(19) United States
(12) Patent Application Publication
(10) Pub. No.: US 2006/0197357 A1
(43) Pub. Date: Sep. 7, 2006

(54) Vehicle door system

(75) Inventor: Michael Vito Catania, Clarkston, MI (US)

Correspondence Address: CARLSON, GASKEY & OLDS, P.C., 400 WEST MAPLE ROAD, SUITE 350, BIRMINGHAM, MI, 48009, US

(73) Assignee: ArvinMeritor Technology, LLC

(21) Appl. No.: 11/071,146

(22) Filed: Mar. 3, 2005

(51) Int. Cl. B60J 5/06

(52) U.S. Cl. 296/155

(57) ABSTRACT

A vehicle door assembly combines features from cargo door systems and sliding door systems to provide remote access and keyless entry on both side and rear vehicle door assemblies. The vehicle door assembly includes a first door panel and a second door panel that cooperate to cover a rear or side door opening in a vehicle body. The first door panel slides relative to the second door panel on a sliding track mechanism to uncover a portion of the rear or side door opening. This movement can be achieved manually or by remote access. The first and second door panels can then be pivoted relative to the vehicle body to fully uncover the rear or side door opening. This allows cargo to be easily loaded and unloaded from the vehicle body.

### TECHNICAL FIELD

The subject invention relates to a vehicle door system that both slides and pivots to provide keyless entry, remote access, and full cargo access in rear and side door assemblies.

### BACKGROUND OF THE INVENTION

Currently, mini vans, sport utility vehicles, full-size vans, and other similar vehicles have a variety of side and rear access doors. Some examples of rear access doors include Dutch doors, lift gates, and cargo style doors. Some examples of side access doors include sliding doors and cargo style doors.

Cargo style doors can have various different configurations. In a side access door configuration, the cargo style door typically includes a single door panel that is pivoted about one door edge between open and closed positions. In a rear access door configuration, the cargo style door typically includes two (2) door panels that pivot about opposite outboard door edges between open and closed positions. Either one of the two door panels can be independently pivoted to the open position to provide partial access to a rear cargo area, or both door panels can be pivoted to the open position to provide full access to the rear cargo area.

Sliding doors require a track system and alignment mechanism. The track systems and alignment mechanisms are typically unique to different body styles. This proliferates parts and increases cost. Additionally, sliding doors require different mounting mechanisms than cargo style doors, which reduces the ability to commonize components. Further, sliding doors are typically not an option for a rear access door configuration because track systems are not feasible due to vehicle shape. However, sliding doors offer an opportunity to have keyless entry and a remote door opening system, which are not available with traditional cargo style doors.

Thus, it is desirable to have a vehicle door system that can be used for both rear and side access door configurations, and which provides keyless entry and remote access, in addition to overcoming the other above-mentioned deficiencies in the prior art.

### SUMMARY OF THE INVENTION

A vehicle door assembly includes first and second door panels that cooperate to cover a door opening formed within a vehicle body. The door opening can be either a side door opening or a rear door opening. The first door panel moves relative to the second door panel to provide access to a portion of the door opening. The first and second door panels can then optionally be moved relative to the vehicle body to provide full access to the door opening.

A first operating mechanism couples the first and second door panels together. A second operating mechanism couples the second door panel to the vehicle body. In one example, the first operating mechanism comprises a sliding track that is mounted to the second door panel, and which allows the first door panel to slide relative to the second door panel. The first operating mechanism can be manually actuated or can be activated remotely with a key fob or other similar mechanism. The second operating mechanism comprises a hinge assembly that connects the second door panel to the vehicle body. If full cargo access is required, i.e. if the door opening is to be completely uncovered, the first and second door panels are pivoted relative to the vehicle body about an axis defined by the hinge assembly. The first and second door panels can be pivoted on the hinge assembly either before or after sliding of the first door panel relative to the second door panel occurs.

The subject invention provides a door assembly that can be easily incorporated into a side or rear access door configuration, which allows common components to be used for all vehicle types. Further, the subject invention provides keyless entry and remote access for both rear and side access door configurations. These and other features of the present invention can be best understood from the following specification and drawings, the following of which is a brief description.

### BRIEF DESCRIPTION OF THE DRAWINGS

FIG. 1A is a partial perspective view showing a rear access door configuration incorporating the subject invention with a rear door being in a closed position.

FIG. 1B is a view similar to that shown in FIG. 1A, but shows the rear door in a partial open position.

FIG. 1C is a view similar to that shown in FIG. 1A, but shows the rear door in a fully open position.

FIG. 1D is a view similar to that shown in FIG. 1A, but shows the rear door in a fully open position and with the rear door being slid back along a vehicle body in a second stage.

FIG. 2A is a partial perspective view showing a side access door configuration incorporating the subject invention with a side door being in a closed position.

FIG. 2B is a view similar to that shown in FIG. 1A, but shows the side door in a partial open position.

FIG. 2C is a view similar to that shown in FIG. 1A, but shows the side door in a fully open position.

### DETAILED DESCRIPTION OF THE PREFERRED EMBODIMENT

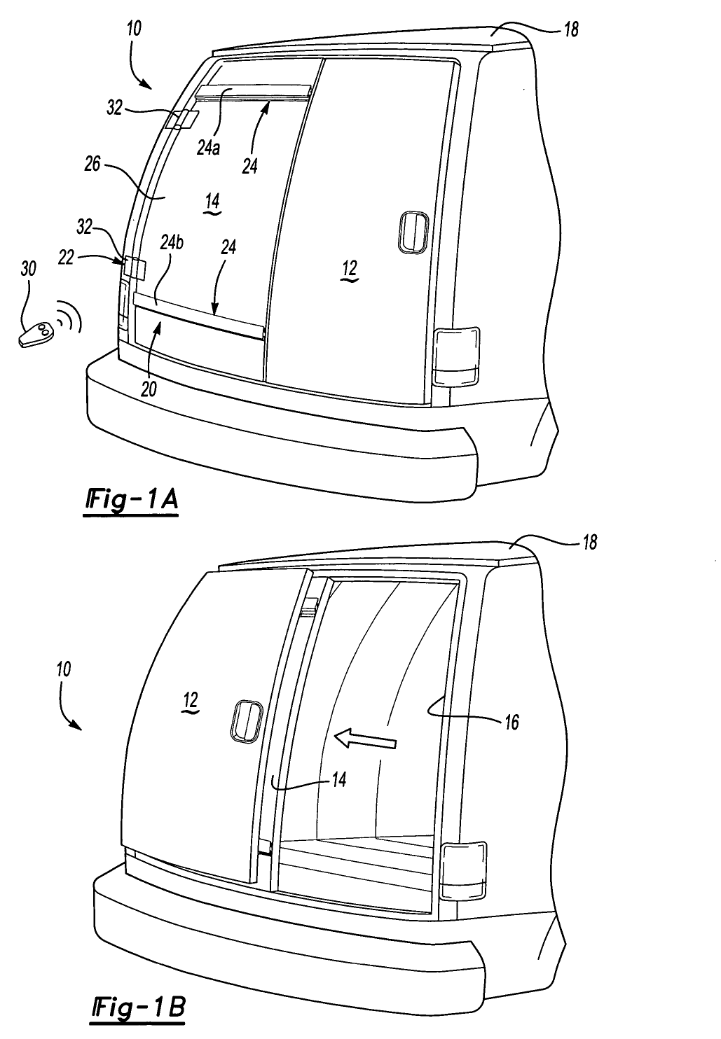

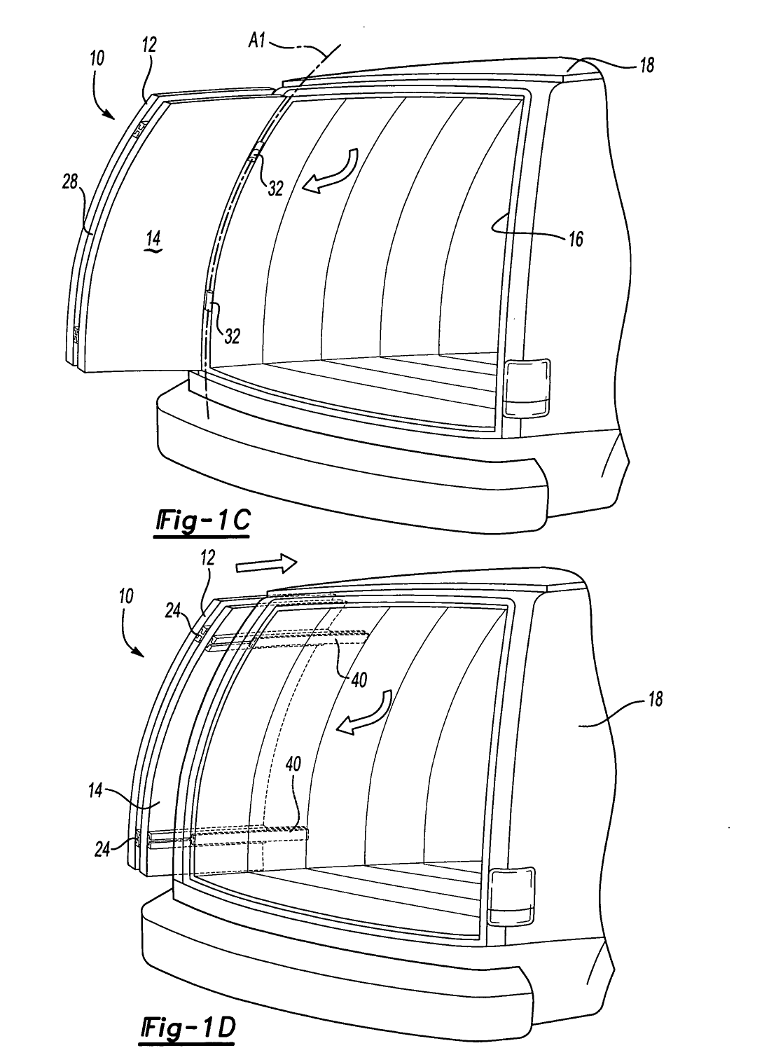

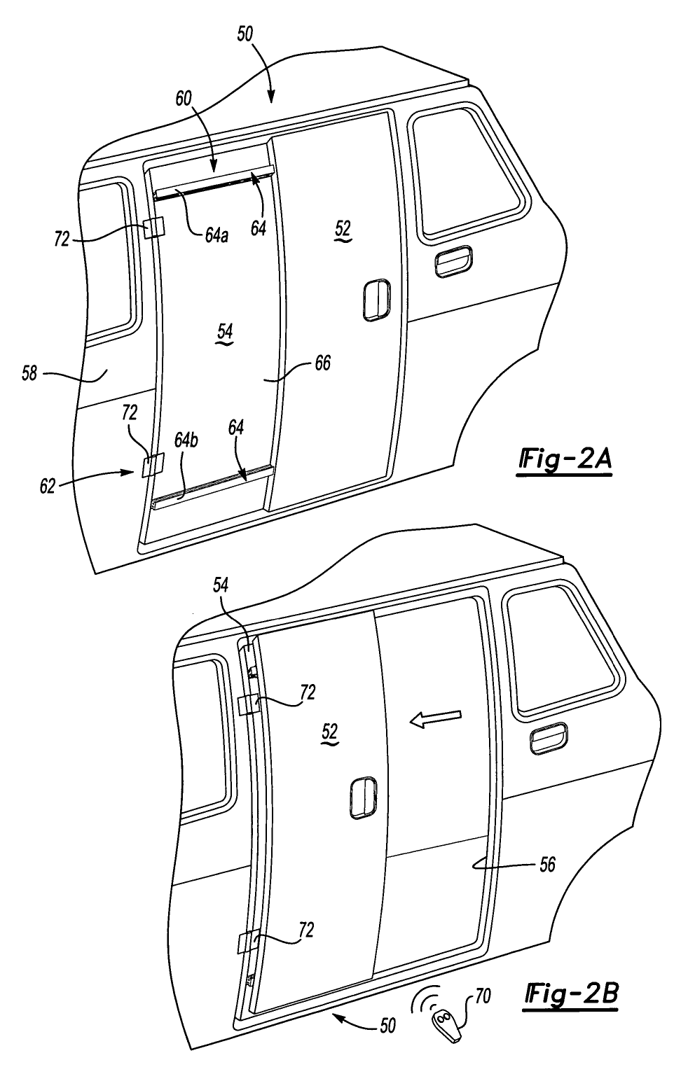

A rear door assembly for a vehicle is shown generally at 10 in FIGS. 1A-1D. The rear door assembly 10 includes a first door panel 12 and a second door panel 14 that cooperate to cover a rear door opening 16 in a vehicle body 18. A first door operating mechanism 20 couples the first door panel 12 to the second door panel 14. A second door operating mechanism 22 couples the second door panel 14 to the vehicle body 18. The first 20 and second 22 door operating mechanisms cooperate to move the rear door assembly 10 between a closed position and an open position.

In the example shown, the first door operating mechanism 20 comprises a sliding track 24 that allows the first door panel 12 to slide relative to the second door panel 14. The sliding track 24 is supported by an exterior surface 26 of the second door panel 14 and is coupled to an interior surface 28 of the first door panel 12. The sliding track 24 includes a first rail component 24a at an upper door position and a second rail component 24b at a lower door position. However, it should be understood that additional rail components or only a single rail component could be required as determined by a specific vehicle configuration.

The first door panel 12 slides over the second door panel 14 along a generally axial path to provide reduced or partial access to a rear cargo area via the rear door opening 16, as shown in FIG. 1B. Generally, when the first door panel 12 moves relative to the second door panel 14, half of the rear door opening 16 is uncovered. However, the rear door assembly 10 could be configured to have door panels of varying sizes.

The first door operating mechanism 20, which slides the first door panel 12 relative to the second door panel 14, can be manually actuated or can be remotely activated by a key fob 30 or other similar mechanism. The key fob 30 includes a transmitter (not shown) and the vehicle includes a receiver (not shown) that cooperate to provide keyless entry and remote access to the rear door opening 16 in a known manner.

In the example shown, the second door operating mechanism 22 comprises a pivoting mechanism or a hinge assembly 32 that connects the second door panel 14 to the vehicle body 18. Once the first door panel 12 has been slid relative to the second door panel 14, the first 12 and second 14 door panels may then be pivoted as a unit relative to the vehicle body 18 about an axis A1 defined by the hinge assembly 32. The first 12 and second 14 door panels can be pivoted on the hinge assembly 32 along a generally arcuate path to provide a fully open position, as shown in FIG. 1C. In this position, there is complete, unimpeded access to the rear cargo area.

Optionally, the first 12 and second 14 door panels can be pivoted on the hinge assembly 32 without sliding the first door panel 12 relative to the second door panel 14. However, the activation of the first door operating mechanism 20 to slide the first door panel 12 relative to the second door panel 14 provides the beneficial features of keyless entry and remote access, as discussed above.

An alternate configuration is shown in FIG. 1D. In this configuration, a third door operating mechanism 40, shown schematically in a dashed outline, is used to couple the second door panel 14 to the vehicle body 18. The third door operating mechanism 40 is a track system, similar to that used for the first door operating mechanism 20, and which is supported by an exterior side surface of the vehicle body 18. The third door operating mechanism 40 is coupled to an interior surface of the second door panel 14. After the first 12 and second 14 door panels have been pivoted to a fully open position (FIG. 1C), both the first 12 and second 14 door panels can then optionally be slid back relative to the vehicle body 18 along the track system, as shown in FIG. 1D.

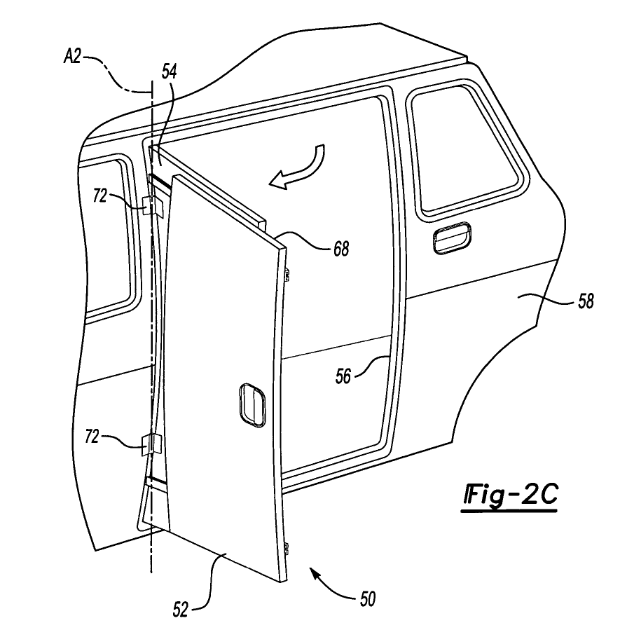

The subject invention can also be utilized in a side door assembly, shown generally at 50 in FIGS. 2A-2C. The side door assembly 50 includes a first door panel 52 and a second door panel 54 that cooperate to cover a side door opening 56 in a vehicle body 58. A first door operating mechanism 60 couples the first door panel 52 to the second door panel 54. A second door operating mechanism 62 couples the second door panel 54 to the vehicle body 58. The first 60 and second 62 door operating mechanisms cooperate to move the side door assembly 50 between a closed position and an open position.

In the example shown, the first door operating mechanism 60 comprises a sliding track 64 that allows the first door panel 52 to slide relative to the second door panel 54. The sliding track 64 is supported by an exterior surface 66 of the second door panel 54 and is coupled to an interior surface 68 of the first door panel 52. The sliding track 64 includes a first rail component 64a at an upper door position and a second rail component 64b at a lower door position. However, it should be understood that additional rail components or only a single rail component could be required as determined by a specific vehicle configuration.

The first door panel 52 slides over the second door panel 54 along a generally axial path to provide reduced or partial access to a passenger area via the side door opening 56, as shown in FIG. 2B. Generally, when the first door panel 52 moves relative to the second door panel 54, half of the side door opening 56 is uncovered. However, the side door assembly 50 could be configured to have door panels of varying sizes.

The first door operating mechanism 60, which slides the first door panel 52 relative to the second door panel 54, can be manually actuated or can be remotely activated by a key fob 70 or other similar mechanism. The key fob 70 includes a transmitter (not shown) and the vehicle includes a receiver (not shown) that cooperate to provide keyless entry and remote access to the side door opening 56 in a known manner.

In the example shown, the second door operating mechanism 62 comprises a pivoting mechanism or a hinge assembly 72 that connects the second door panel 54 to the vehicle body 58. Once the first door panel 52 has been slid relative to the second door panel 54, the first 52 and second 54 door panels are then pivoted as a unit relative to the vehicle body 58 about an axis A2 defined by the hinge assembly 72. The first 52 and second 54 door panels can be pivoted on the hinge assembly 72 along a generally arcuate path to achieve a fully open position, as shown in FIG. 2C. This provides full access to the passenger area, which allows passengers to easily enter and exit the vehicle.

Optionally, the first 52 and second 54 door panels can be pivoted on the hinge assembly 72 without sliding the first door panel 52 relative to the second door panel 54. However, the activation of the first door operating mechanism 60 to slide the first door panel 52 relative to the second door panel 54 provides the beneficial features of keyless entry and remote access, as discussed above.

The subject invention provides a vehicle door assembly that can be easily incorporated into a side or rear access door configuration. This allows common components to be used for all vehicle types, and offers the option of easily providing door module assemblies. Further, the subject invention provides keyless entry and remote access for both rear and side access door configurations.

The subject invention is shown schematically in FIGS. 1-2. It should be understood that mechanisms for driving and guiding vehicle door panels are well-known. Any type of door drive mechanisms, door pivoting mechanisms, and door sliding mechanisms can be used to move the vehicle door panels according to the invention to achieve the desired inventive door panel assembly configuration.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A vehicle door assembly comprising:
a first door panel;
a second door panel adapted for cooperation with said first door panel to cover a door opening in a vehicle body;
a first operating mechanism adapted to move one of said first and said second door panels relative to the other of said first and said second door panels to provide partial access to the door opening; and
a second operating mechanism adapted to move both of said first and said second door panels relative to the vehicle body to provide full access to the door opening.

2. The vehicle door assembly according to claim 1 wherein said first operating mechanism moves said one of said first and said second door panels relative to the other of said first and said second door panels along a generally axial path and wherein said second operating mechanism moves both said first and said second door panels relative to the vehicle body along a generally arcuate path.

3. The vehicle door assembly according to claim 1 wherein said first operating mechanism comprises a sliding track.

4. The vehicle door assembly according to claim 1 wherein said second operating mechanism comprises a pivot connection.

5. The vehicle door assembly according to claim 1 wherein said first operating mechanism comprises a sliding track and said second operating mechanism comprises at least one hinge.

6. The vehicle door assembly according to claim 1 wherein said first and said second door panels comprise a side door assembly.

7. The vehicle door assembly according to claim 1 wherein said first and said second door panels comprise a rear door assembly.

8. The vehicle door assembly according to claim 1 wherein said first operating mechanism is supported by said first door panel and is coupled to said second door panel to allow said second door panel to slide relative to said first door panel to provide a partially open position.

9. The vehicle door assembly according to claim 8 wherein said second operating mechanism pivotally connects said first door panel to the vehicle body to allow said first and said second door panels to pivot together relative to the vehicle body to provide a fully open position.

10. The vehicle door assembly according to claim 9 including a third operating mechanism that is adapted for support by the vehicle body and is coupled to said first door panel to allow said first and second door panels to slide as a unit relative to the vehicle body subsequent to being pivoted to the fully open position.

11. The vehicle door assembly according to claim 1 wherein said first operating mechanism is remotely activated.

12. A method for moving a vehicle door assembly to provide access to a door opening formed within a vehicle body comprising the steps of:
(a) moving a first door panel relative to a second door panel to move the vehicle door assembly to a first position; and
(b) moving the first and the second door panels relative to the vehicle body to move the vehicle door assembly to a second position different from the first position.

13. The method according to claim 12 wherein the first position is a partially open position and the second position is a fully open position.

14. The method according to claim 12 wherein step (a) includes sliding the first door panel relative to the second door panel.

15. The method according to claim 12 wherein step (b) includes pivoting the first and the second door panels as a unit relative to the vehicle body.

16. The method according to claim 12 wherein step (a) includes sliding the first door panel relative to the second door panel and wherein step (b) includes pivoting the first and the second door panels as a unit relative to the vehicle body subsequent to step (a).

17. The method according to claim 12 including supporting a first operating mechanism on the second door panel, coupling the first door panel to the first operating mechanism, supporting a second operating mechanism on the vehicle body, and coupling the second door panel to the second operating mechanism.

18. The method according to claim 17 wherein the first operating mechanism comprises a sliding track and the second operating mechanism comprises a hinge assembly, and wherein step (a) includes sliding the first door panel relative to the second door panel along the sliding track to move the vehicle door assembly to a partially open position, and wherein step (b) includes pivoting the first and the second door panels together about an axis defined by the hinge assembly to move the vehicle door assembly to a fully open position.

19. The method according to claim 18 including supporting a third operating mechanism on the vehicle body, coupling the third operating mechanism to the second door panel, and sliding the first and the second door panels as a unit relative to the vehicle body subsequent to step (b).

20. The method according to claim 17 including remotely activating the first operating mechanism in response to a transmitted user command.
